(19) United States
(12) Patent Application Publication
(10) Pub. No.: US 2014/0300293 A1
(43) Pub. Date: Oct. 9, 2014

(54) LED LIGHTING DEVICE AND AN LEDLIGHTING NETWORK SYSTEM

(71) Applicant: ZHEJIANG SHENGHUI LIGHTING CO., LTD, Jiaxing (CN)

(72) Inventors: JIAYANG RUAN, Jiaxing (CN); JINXIANG SHEN, Jiaxing (CN)

(73) Assignee: ZHEJIANG SHENGHUI LIGHTING CO., LTD.

(21) Appl. No.: 14/311,928

(22) Filed: Jun. 23, 2014

Related U.S. Application Data
(63) Continuation-in-part of application No. PCT/CN2012/086655, filed on Dec. 14, 2012.

(30) Foreign Application Priority Data
Aug. 16, 2012 (CN) 201210292575.6

(51) Int. Cl. H05B 33/08

(52) U.S. Cl. CPC H05B 33/0842
USPC 315/294; 315/291

(57) ABSTRACT

The present invention provides an LED lighting device and an LED lighting network system. The LED lighting device includes an LED lighting unit, an LED driving circuit, a controller, and a Wi-Fi module configured to send and receive Wi-Fi signals. The LED driving circuit connects to the LED lighting unit. The controller connects to the Wi-Fi module and the driving circuit. The LED lighting network system includes two or more of the above LED lighting devices. Each LED lighting device works as a network node, which transmits received Wi-Fi data to other LED lighting devices within its coverage range. The LED lighting devices may form a mesh network. Each LED lighting device may act as a gateway, a network accessing point, or a repeater. The LED lighting network can receive and transmit Wi-Fi signals. In a mesh network, Wi-Fi signals can be transmitted from one layer of LED lighting devices to the next layer. Embodiments consistent with the present disclosure can overcome lighting network problems caused by obstacles in the Wi-Fi transmission range or the limitation of the Wi-Fi signal transmission range.

### CROSS-REFERENCES TO RELATED APPLICATIONS

This application is a continuation in part and claims the priority of Chinese Patent Application No. 201210544078.0 (PCT/CN2012/086655) filed on Dec. 14, 2012, which claims the priority of Chinese Patent Application No. 201210292575.6, filed on Aug. 16, 2012. The entire contents of both Chinese Patent Applications are incorporated herein by reference.

### FIELD OF THE DISCLOSURE

The present disclosure relates to the field of light emitting diode (LED) technologies and, more particularly, relates to LED lighting devices with Wi-Fi capacities and the related lighting network.

### BACKGROUND

Intelligent lighting control devices and systems are well-researched topics of the new generation of lighting solutions. Currently, widely used lighting control methods include:
1. Sensor Based Methods. Sensors are used to monitor operating conditions. For example, light intensity sensors may monitor the ambient brightness. Then the lighting devices may be turned on or off according to the light intensity measurements.
2.Fixed Wire Network Based Methods. Lighting devices are connected to a wired network. The status of the lighting devices in the wired network may be monitored and controlled through the network.
3. Wireless Network Based Methods. Lighting devices have Wi-Fi or other wireless capabilities, and are connected to a Wi-Fi or other wireless network. These lighting devices may receive and send data through the wireless network, and may be controlled remotely.

Among the above lighting control methods, the wireless network based methods are the most popular because it is convenient to use and easy to set up. However, traditional wireless lighting networks often have limited wireless signal coverage areas because of constraints such as obstacles in the coverage area and limited signal transmission distance. Such constraints have made the wireless network based lighting control less reliable and less convenient to use.

For example, FIG. 1 shows a traditional Wi-Fi based lighting system, which includes an external Wi-Fi router 10, lighting devices 21, 22, 31, and 32. Lighting devices 21 and 22 are located in the Wi-Fi signal coverage area, while lighting devices 31 and 32 are located outside the Wi-Fi signal coverage area. Lighting devices 31 and 32 are located in area 40, which does not have Wi-Fi signal coverage. As s a result, lighting devices 31 and 32 cannot receive Wi-Fi signals and cannot be controlled through the Wi-Fi network. Moreover, in this type of wireless networks, routers and/or lighting devices are often connected in star shaped configurations. The lighting devices also cannot transmit data among themselves. As a result, the Wi-Fi based lighting system may be limited by the transmission distance of the Wi-Fi signals.

The disclosed method and system are directed to solve one or more problems set forth above and other problems.

### BRIEF SUMMARY OF THE DISCLOSURE

Embodiments consistent with the present disclosure provide LED lighting devices with Wi-Fi functions. The LED lighting devices may form a mesh or ad hoc network that may be connected to a local area network or the internet. The network of such LED lighting devices thus expands the coverage range of the network beyond the transmission range of Wi-Fi signals. Embodiments consistent with the present disclosure enable users to remotely monitor and control the LED lighting devices.

One aspect of the present disclosure provides an LED lighting device with Wi-Fi functions. The LED lighting device includes an LED lighting unit configured to emit light; an LED driving circuit configured to drive the LED lighting unit, the LED driving circuit being connected to the LED lighting unit; a controller configured to control the LED lighting unit; and a Wi-Fi module configured to receive and send data.

Another aspect of the present disclosure also provides an LED lighting device with Wi-Fi functions. The LED lighting device includes an LED lighting unit configured to emit light; an LED driving circuit configured to drive the LED lighting unit; a controller configured to control the LED lighting unit, the controller being connected to the LED driving circuit; and a Wi-Fi module configured to receive and send data, the Wi-Fi module being connected to the LED driving circuit and the LED lighting unit. Further, the controller may be integrated into the Wi-Fi module.

Moreover, the controller of the LED lighting device may connect to the LED driving circuit and the Wi-Fi module. The Wi-Fi module may use an external antenna or an internally integrated antenna. The Wi-Fi module may also use an antenna located inside or outside the LED lighting device.

In addition, the Wi-Fi module may connect the LED lighting device to the internet or a local area network. The Wi-Fi module may be a wireless gateway, a wireless access point, or a wireless repeater. The Wi-Fi module may work at 2.4 GHz or 5 GHz. The controller may be a micro controller or a digital integrated circuit controller.

Another aspect of the present disclosure provides an LED lighting network system. The LED lighting network includes two or more LED lighting devices forming a mesh or ad hoc network. Each LED lighting device includes an LED lighting unit configured to emit light; an LED driving circuit configured to drive the LED lighting unit, the LED driving circuit being connected to the LED lighting unit; a controller configured to control the LED lighting unit; and a Wi-Fi module configured to receive and send data. Further, each LED lighting device works as a network node, transmitting signals to other LED lighting devices within its coverage range.

In addition, the LED lighting network may be connected to internet or local area network through Wi-Fi signals. Each LED lighting device may be a wireless access point, a wireless gateway, or a repeater. A remote terminal that can monitor the status of and control each LED lighting device may be connected to each LED lighting device in the lighting network using Wi-Fi signals. The remote terminal may be a computer, a tablet, or a smart phone.

### BRIEF DESCRIPTION OF THE DRAWINGS

The following drawings are merely examples for illustrative purposes according to various disclosed embodiments and are not intended to limit the scope of the present disclosure.

FIG. 1 is an exemplary schematic of a traditional wireless network based lighting system consistent with various disclosed embodiments;

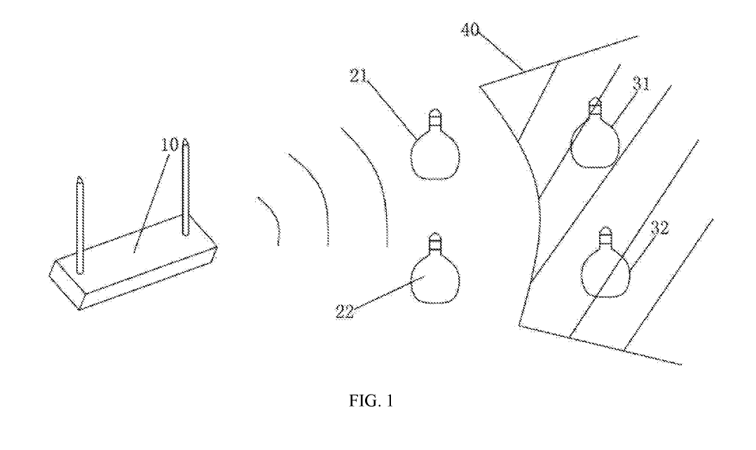

FIG. 2 shows an exemplary configuration of an LED lighting device consistent with various disclosed embodiments;

FIG. 3 shows another exemplary configuration of an LED lighting device consistent with various disclosed embodiments;

FIG. 4 shows an exemplary LED lighting network system consistent with various disclosed embodiments; and

FIG. 5 shows another exemplary configuration of an LED lighting device consistent with various disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

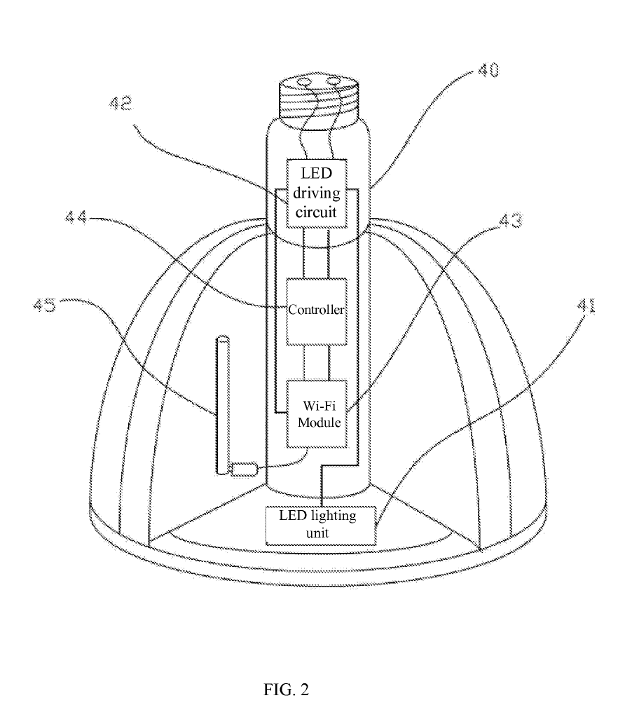

An exemplary embodiment consistent with the present disclosure is described below. FIG. 2 illustrates an exemplary LED lighting device consistent with the present disclosure. The LED lighting device includes an LED lighting unit 41, an LED driving circuit 42, a Wi-Fi module 43, and a controller 44. As shown in FIG. 2, the driving circuit 42 may connect to the Wi-Fi module 43, to the LED lighting unit 41, and to the controller 44. The controller 44 may connect to the Wi-Fi module 43 as well.

The Wi-Fi module 43 may work at 2.4 GHz, 5 GHz, or other working frequencies. The Wi-Fi module 43 may be placed inside the LED lighting device. For example, it may be integrated onto the same circuit board that holds the driving circuit 42. It may also be placed outside the LED lighting device.

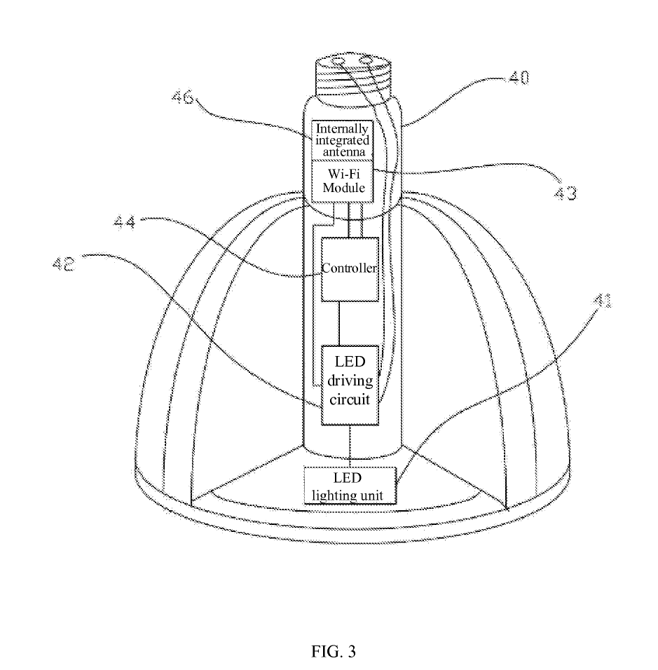

The antenna 45 may be a separate antenna that is placed outside the LED lighting device as shown in FIG. 2. It may also be an integrated antenna and may be placed inside the LED lighting device. For example, in FIG. 3 the LED lighting device 40 may use an internally integrated antenna 46. More specifically, the Wi-Fi antenna 46 may be integrated with the Wi-Fi module 43 and be placed on the same PCB board. In this embodiment, the overall size of the LED lighting device may be reduced.

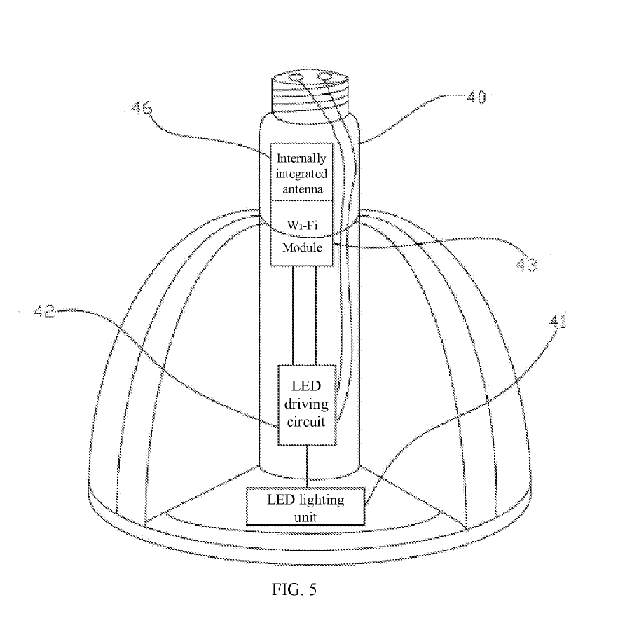

The controller 44 may be connected to the driving circuit 42. The controller 44 may monitor the LED light operating status such as whether the device is on or off, or light intensity measurements. The controller 44 may also send data received by the Wi-Fi module 43 to the LED driving circuit 42 to control the LED lighting unit 41 including switching lighting on/off, adjusting light intensity and light color, etc. Moreover, the controller 44 may send Pulse Width Modulation (PWM) signals and analog signals to the light adjusting port at the LED driving circuit 42 directly after it receives a light adjusting instruction sent by the Wi-Fi module 43. In addition, the controller 44 may be a micro controller and/or a digital integrated circuit controller, or it may be an integrated circuit controller, which can be integrated with the Wi-Fi module 43 as shown in FIG. 5.

The LED lighting unit 42 may include several light bulbs. These light bulbs may be connect to the same controller, and may be controlled and monitored together or separately.

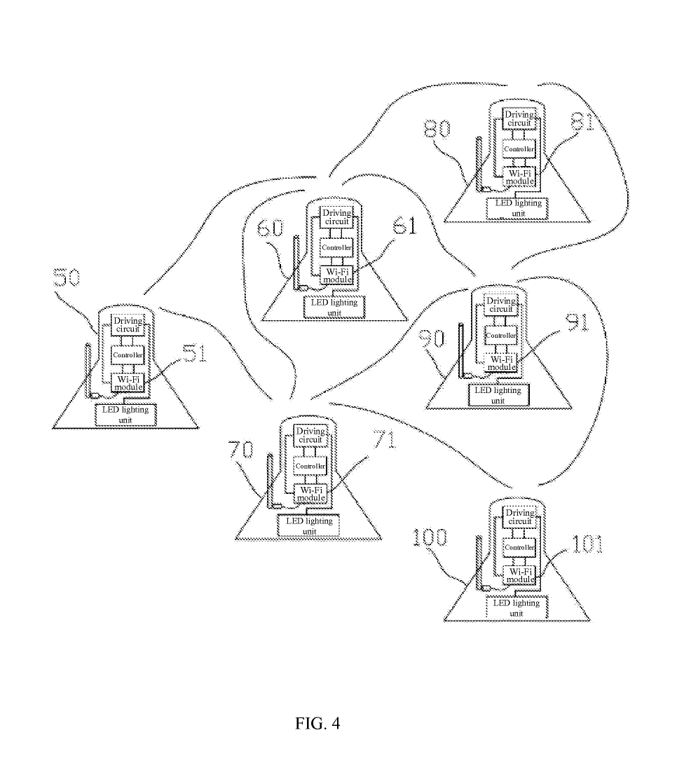

FIG. 4 illustrates an exemplary LED lighting network consistent with the present disclosure. As shown in FIG. 4, devices 50, 60, 70, 80, 90, and 100 are LED lighting devices consistent with the above embodiments. The Wi-Fi module 61 and 71 can communicate with the Wi-Fi module 51 on the LED lighting device 50. The LED lighting device 50 therefore communicate with the LED lighting devices 60 and 70. In the meantime, LED lighting devices 60 and 70 may work as repeaters, through which the LED lighting device 50 may communicate with the LED lighting devices 80, 90, and 100. A Wi-Fi mesh network may thus be established using this and similar arrangements. Wi-Fi signals may therefore be transmitted between any two LED lighting devices directly or through other LED lighting devices.

The LED lighting network system may be connected to the internet or a local area network. Each LED lighting device in the system may also function as a wireless gateway or a wireless access point. Users may surf the web, stream and download data through such a wireless access point.

Moreover, a user may control each of the LED lighting devices in the system through a connected terminal device. For example, smart phones with proper programs may be used to control switching the LED lighting devices on/off, or adjusting light intensity, light color, etc., remotely. This enables users to control lights of large buildings such as office buildings or shopping malls.

Embodiments consistent with the present disclosure provide LED lighting devices with Wi-Fi modules. The LED lighting devices may work as repeaters, and may form a mesh or ad hoc network. An LED lighting network consistent with the present disclosure may overcome the coverage limitations of traditional wireless lighting networks. The LED lighting network consistent with the present disclosure may connect to the internet or a local area network. Each LED lighting device in the network may work as a Wi-Fi wireless access point. Users may remotely control LED lighting devices through any of the access points or through a network connection.

In various embodiments, the LED lighting device can be configured as one single device. For example, the LED driving circuit, the controller, the Wi-Fi module, and the LED lighting unit can be integrated to form the single device. Accordingly, the LED lighting network system can include a plurality of the LED lighting devices each configured as one single device.

In an exemplary LED lighting device, to ensure the Wi-Fi module functions as desired, an embedded antenna can be included in the integrated LED lighting device. The embedded antenna can be configured to fit a shape of the lamp body of the LED lighting device without increasing size of the resultant device and to maintain the design of the resultant device. In various embodiments, the Wi-Fi module can be configured with slow-down functions to avoid interference with other wireless devices.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In some embodiments consistent with the present disclosure, various sensors may be attached to an LED lighting device to measure other parameters. For example, light intensity sensors may be placed on the LED lighting device to measure light intensity; humidity or temperature sensors may be arranged on the LED lighting device to measure humidity and temperature. The measured data from various sensors may be transferred by the Wi-Fi signals, and may be retrieved by a control terminal connected to the LED lighting device. The controller may control the LED lighting devices based on the readings from the sensors (e.g., decrease light intensity if the measured operating temperature is very high).

In some embodiments consistent with the present disclosure, a display unit may be attached to an LED lighting device, which can be used to display various LED parameters such as network connectivity, power consumption, lifespan, light intensity, etc. For example, the display unit may display the LED lighting network with markings showing whether each LED lighting device is actively connected to the Wi-Fi network. The display terminal may also be used to display informations from the control terminal such as an emergency notice, an alert, an advertisement, etc.

What is claimed is:

1. An LED lighting device with wireless network capabilities, comprising:
an LED lighting unit configured to emit light;
an LED driving circuit configured to drive the LED lighting unit, the LED driving circuit being connected to the LED lighting unit;
a controller configured to control the LED lighting unit; and
a Wi-Fi module configured to receive and send data, the Wi-Fi module sending data to another LED lighting device.

2. An LED lighting device with wireless network capabilities, comprising:
an LED lighting unit configured to emit light;
an LED driving circuit configured to drive the LED lighting unit;
a controller configured to control the LED lighting unit, the controller being connected to the LED driving circuit; and
a Wi-Fi module configured to receive and send data, the Wi-Fi module being connected to the LED driving circuit and the LED lighting unit;
wherein the controller is integrated into the Wi-Fi module; and the Wi-Fi module sends data to another LED lighting device.

3. The LED lighting device according to claim 1, wherein the controller connects to the LED driving circuit and the Wi-Fi module.

4. The LED lighting device according to claim 1, wherein the Wi-Fi module uses an external antenna or an internally integrated antenna.

5. The LED lighting device according to claim 2, wherein the Wi-Fi module uses an external antenna or an internally integrated antenna.

6. The LED lighting device according to claim 1, wherein the Wi-Fi module connects the LED device to the internet or a local area network.

7. The LED lighting device according to claim 2, wherein the Wi-Fi module connects the LED device to the internet or a local area network.

8. The LED lighting device according to claim 1, wherein the Wi-Fi module acts as a wireless access point, a gateway, or a repeater.

9. The LED lighting device according to claim 2, wherein the Wi-Fi module acts as a wireless access point, a gateway, or a repeater.

10. The LED lighting device according to claim 1, wherein the Wi-Fi module works at 2.4 GHz or 5 GHz.

11. An LED lighting network system with two or more LED lighting devices forming a mesh or ad hoc wireless network, each LED lighting device comprising:
an LED lighting unit configured to emit light;
an LED driving circuit configured to drive the LED lighting unit, the LED driving circuit being connected to the LED lighting unit;
a controller configured to control the LED lighting unit; and
a Wi-Fi module configured to receive and send data;
wherein each LED lighting device works as a network node, transmitting signals to other LED lighting devices within its Wi-Fi coverage range.

12. The LED lighting network system according to claim 11, wherein the system is connected to the internet or a local area network through Wi-Fi signals.

13. The LED lighting network system according to claim 11, wherein each LED lighting device acts as a wireless gateway, a wireless access point, or a wireless repeater.

14. The LED lighting network system according to claim 11, wherein a remote terminal, which monitors status of an LED lighting device and controls the LED lighting device, is connected to the LED lighting device in the LED lighting network using Wi-Fi signals.

15. The LED lighting network system according to claim 14, wherein the remote terminal is a computer, a tablet, or a smartphone.
